(19) United States
(12) Patent Application Publication
(10) Pub. No.: US 2015/0170062 A1
(43) Pub. Date: Jun. 18, 2015

(54) Methods and Systems for Facilitating Admissions

(71) Applicant: PEATIX INC., Tokyo (JP)

(72) Inventors: Taku Harada, New York, NY (US); Akira Sawada, Tokyo (JP)

(21) Appl. No.: 14/521,405

(22) Filed: Oct. 22, 2014

Related U.S. Application Data
(60) Provisional application No. 61/894,789, filed on Oct. 23, 2013.
(60) Provisional application No. 61/937,411, filed on Feb. 7, 2014.

(51) Int. Cl. G06Q 10/02

(52) U.S. Cl. CPC G06Q 10/02

(57) ABSTRACT

Methods and systems for granting or regulating attendee access to an event or location are provided. A method for regulating attendee access to an event or location comprises receiving a first identifier on an electronic device of a checker that regulates access to the event or location. The first identifier can comprise at least one graphical item, such as a color. In an example, the color is an image color or a background color. Next, a second identifier on an electronic device of an attendee is reviewed by the checker. The second identifier can comprise at least graphical item. The attendee is granted access to the event or location if the first identifier matches the second identifier.

### CROSS-REFERENCE

This application claims priority to U.S. Provisional Patent Application Ser. No. 61/894,789, filed Oct. 23, 2013, and U.S. Provisional Patent Application No. 61/937,411, filed Feb. 7, 2014, each of which is entirely incorporated herein by reference.

### BACKGROUND

A ticket may be used to admit a subject to an event or establishment, such as, for example, a theater, movie theater, amusement park, zoo, museum, stadium, concert, or other attraction, or grant the subject permission to travel on a vehicle, such as an airliner, train, bus, or boat. A ticket may be a voucher that indicates that a subject has paid for admission to an event or establishment, or has paid the fare for travel. A ticket may be free or be provided at a cost, and serve as a proof of reservation or right of access to an event or establishment, or other area, location or event in which access is regulated.

A subject wishing to be admitted typically purchases a ticket and presents the ticket to an individual that checks the validity of the ticket. If the ticket is deemed to be valid, then the subject may be admitted. If the ticket is deemed to not be valid, then the subject may not be admitted.

### SUMMARY

Recognized herein are various issues with current methods of validating tickets. For large events (e.g., an event with greater than 800 attendees), checking the ticket of each subject may require a substantially large number of checkers who review the tickets for validity to grant admission. This may be resource intensive. Because some checkers operate under time constraints, some tickets may not be accurately checked, making it difficult to ensure that all subjects have been properly granted admission to an event. This may make it difficult to prevent fraudulent admission at high accuracy.

Some establishments may solve this issue by increasing the time between event start and the point in time in which admission is granted, but this may lead to lost time for both the establishment and the subjects that are seeking admission to the establishment for a given event.

Recognized herein is the need for systems and methods that optimize the manner in which tickets are validated and subjects are granted admission to an event.

The present disclosure provides methods and system that enable a venue or establishment to expedite its check-in process by eschewing the one-by-one ticket checking process while maintaining accuracy and security. Systems and methods provided herein can enable a venue to expeditiously check in a substantially large number of subjects (or attendees). This can be implemented using a unique identifier that is presented to a subject and a checker. If the identifier of a given subject matches the identifier of the checker, then the subject is granted admission.

An identifier can be one or more of text, graphic, or sound, or a combination and/or sequence thereof. In some cases, the identifier is a color or a sequence of colors, which may be presented on at least a portion (e.g., background) of an electronic display of an electronic device.

In some examples, during a check in process, a system that is programmed to check in attendees sends a random sequence of colors to an electronic device of each of the attendees and the checker. The checker need only verify that the attendees' color sequence matches his or her own color sequence.

An aspect of the present disclosure provides a method for granting an attendee access to an event or location, comprising presenting a first identifier on an attendee electronic device of an attendee in response to the attendee requesting admission to the event or location, wherein the first identifier comprises at least one graphical item. Next, a second identifier is presented on a checker electronic device of a checker in response to the attendee requesting admission to the event or location, wherein the checker regulates or monitors access to the event or location, and wherein the second identifier is at least partially the same as the first identifier. An indication is then received from the checker electronic device that the attendee has been granted access to the event or location. In an embodiment, the method further comprises directing the attendee electronic device to (i) generate, using a computer processor, the first identifier, and (ii) display the first identifier on an electronic display of the attendee electronic device. In another embodiment, the method further comprises directing the checker electronic device to display the second identifier on an electronic display of the checker electronic device. In another embodiment, the method further comprises storing the indication in a memory location. In another embodiment, the method further comprises displaying the indication on an electronic display of the attendee electronic device. In another embodiment, the method further comprises displaying the indication on an electronic display of the checker electronic device. In another embodiment, the at least one graphical item is a color. In another embodiment, the first or second identifier comprises a sequence of temporally separated graphical items. In another embodiment, the first or second identifier comprises a sequence of colors. In another embodiment, the first identifier is presented when the attendee is at or in proximity to a geographic location of the checker. In another embodiment, the method further comprises (i) determining a geographic location of the attendee and (ii) comparing the geographic location to the geographic location of the checker. In another embodiment, the second identifier is the same as the first identifier.

Another aspect of the present disclosure provides a system for regulating attendee access to an event or location, comprising an attendee electronic device that is operated by an attendee, wherein the attendee electronic device is programmed to present the attendee with a first identifier in response to the attendee requesting admission to the event or location, wherein the first identifier comprises at least one graphical item. The system further comprises a checker electronic device that is operated by a checker that regulates or monitors access to the event or location, wherein the checker electronic device is programmed to present the checker with a second identifier in response to the attendee requesting admission to the event or location, wherein the second identifier is at least partially the same as the first identifier. The system further comprises a server that is in communication with the attendee electronic device and the checker electronic device, wherein the server receives an indication from the checker electronic device that the attendee has been granted access to the event or location. In an embodiment, the sever directs the attendee electronic device to (i) generate, using a computer processor, the first identifier, and (ii) display the first identifier on an electronic display of the attendee electronic device. In another embodiment, the server directs the checker electronic device to display the second identifier on an electronic display of the checker electronic device. In another embodiment, the server comprises memory that stores the indication. In another embodiment, the at least one graphical item is a color. In another embodiment, the first or second identifier comprises a sequence of temporally separated graphical items. In another embodiment, the first or second identifier comprises a sequence of colors. In another embodiment, the server (i) determines whether the attendee is at or in proximity to a geographic location of the checker, and (ii) directs the attendee electronic device to present the first identifier when the attendee is at or in proximity to the geographic location. In another embodiment, the server determines whether the attendee is at or in proximity to the geographic location of the checker using a geographic location system of the attendee electronic device. In another embodiment, the second identifier is the same as the first identifier.

Another aspect of the present disclosure provides a computer readable medium comprising machine executable code that, upon execution by one or more computer processors implements any of the methods above or elsewhere herein.

Another aspect of the present disclosure provides a system comprising one or more computer processors and memory comprising machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 schematically illustrates a method and system for checking in a subject, in accordance with some embodiments of the present disclosure;

FIG. 2 shows a computer system that is programmed or otherwise configured to facilitate subject access to event at an area or location, in accordance with some embodiments of the present disclosure;

FIG. 4 is a screenshot of a graphical user interface (GUI) of a checker showing a list of subjects that have tickets to an event;

FIG. 5 is a screenshot of a GUI of the checker showing an identifier presented by way of background colors. The GUI also shows a list of arrived attendees (subjects) and a title of the event;

FIG. 6 is a screenshot of a GUI of a subject that has a ticket to attend the event of FIGS. 4 and 5;

FIG. 7 is a screenshot of the GUI of FIG. 5 after the checker has admitted the subject of FIG. 6;

FIG. 8 is a screenshot of a user interface of an application (app) that is configured to permit a subject to search for and find events, and check into an event;

FIG. 9 is a screenshot of an event screen of the attendee of FIG. 8;

FIG. 10 is a screenshot of an event screen of the attendee of FIG. 8;

FIG. 11 is a screenshot of a map screen of the attendee of FIG. 8;

FIG. 12 is a screenshot of a ticket of the attendee of FIG. 8;

FIG. 13 is a screenshot of a discover screen of the attendee of FIG. 8; and

FIG. 14 is a screenshot of a profile screen of the attendee of FIG. 8.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “subject,” as used herein, generally refers to an individual (or user) that is seeking admission to an event or establishment, permission to travel, or the right of access to an event, area or location in which access is regulated. A subject can be an attendee of an event or location.

The term “checker,” as used herein, generally refers to an individual or computer system that permits the subject access an event or establishment, permits travel, or allows the subject the right of access an event, area or location in which access is regulated.

The term “ticket,” as used herein, generally refers to a voucher that indicates that a subject has the right of admission to an event or establishment, the right of travel, or the right of access to an event, area or location in which access is regulated. In an example, a ticket is a physical item, such as a paper item. In another example, a ticket is an electronic ticket with graphical and/or textual information that is presented on a user interface (UI), such as a graphical user interface (GUI), of an electronic device of a subject or a checker. As another example, a ticket includes audible information. A ticket can include or be coupled with an identifier that is configured to permit a checker to determine whether the subject is to be admitted to an area or location, such as by validating a ticket of the subject. Such validation can come by way of check-in.

The term “check in,” as used herein, generally refers to a checker validating the admission of a subject, such as by way of validating a ticket of the subject. In some examples, a subject has been checked into an event if a checker has validated the ticket of the subject, or otherwise found that the subject is permitted to attend the event.

The term “identifier,” as used herein, generally refers to a textual, graphical, or audible item, or a sequence or combination thereof, such as, for example, a sequence or combination of graphical items, a sequence or combination of graphical and textual items, or a sequence or combination of graphical and audible items. In some examples, an identifier is a color or a sequence of one or more colors, such as a sequence of red, blue and green colors, or a sequence of red colors.

The term “match” or “the same,” as used herein, generally means equivalent or substantially equivalent to. A first item matches (or is the same as) a second item if the first item is at least 70%, 80%, 90%, 95%, 99%, 99.9%, 99.99%, 99.999%, or 99.9999% equivalent to the second item. For example, a first color matches a second color if the first and second colors are the same colors (e.g., red). On the other hand, the first color and the second color do not match each other if they are different colors.

### Methods for Granting Access to Subjects

The present disclosure provides methods for facilitating subject access or check-in, such as access to an event or establishment, right of travel, or the right of access to any area or location in which access is regulated or otherwise monitored. Methods provided herein can enable the rapid and secure validation of subject access to an event or location. In some examples, the right of access of a subject is validated in a time period of at most about 5 minutes, 1 minute, 30 seconds (s), 20 s, 10 s, 9 s, 8 s, 7 s, 6 s, 5 s, 4 s, 3 s, 2 s, 1 s, or 0.5 s. As such, methods of the present disclosure can substantially increase the rate at which subjects are properly admitted to an event or location, thereby enabling business, for example, to maximize revenue from proper admission and minimize any losses from improper admission.

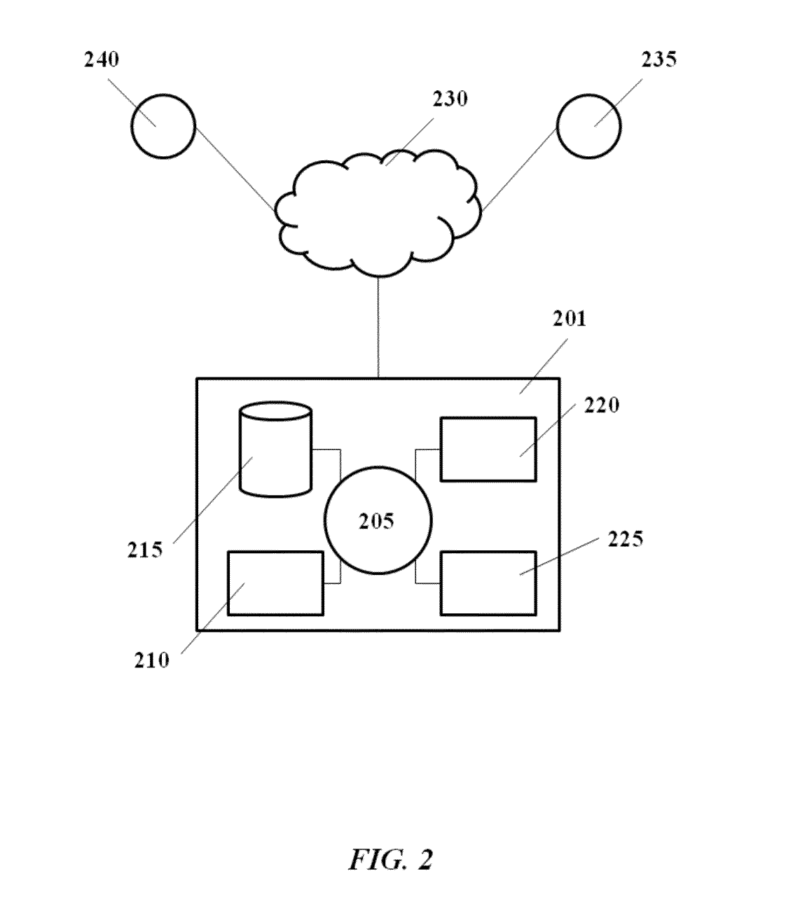

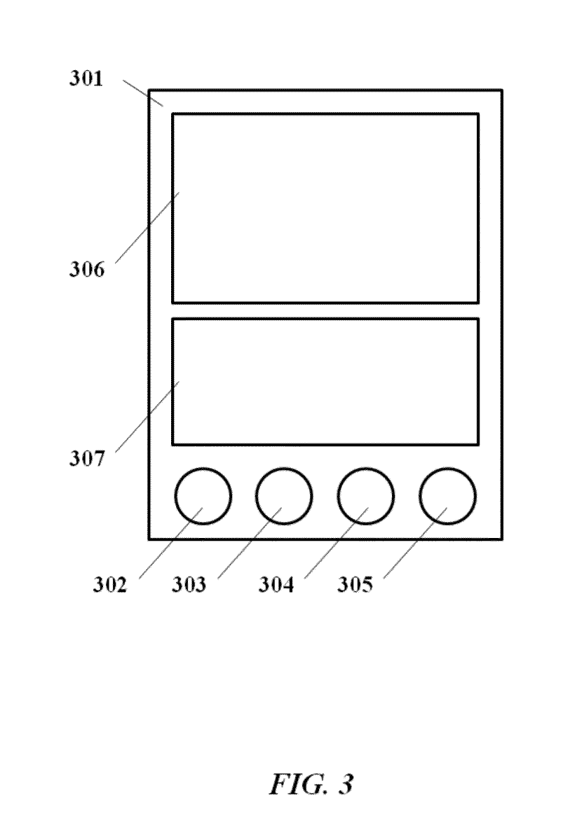

In an aspect, a method for granting a subject access to an area or location comprises directing a first identifier to an electronic device of a checker from a computer system that has a computer processor that is programmed to generate identifiers (see, e.g., FIG. 2). The method further comprises directing a second identifier to an electronic device of a subject from the computer system. The second identifier can be at least partially, substantially, or entirely the same as the first identifier. The checker can then review the second identifier to determine whether the first identifier matches the second identifier. If the first identifier matches the second identifier, then the checker can grant the subject access to the area or location. On the other hand, if the first identifier does not match the second identifier, then the checker does not grant the subject access to the area or location. An indication can be received by the computer system from the electronic device of the checker that the subject has or has not been granted access to the area or location.

The first and second identifier can be directed to the electronic devices of the checker and the subject, respectively, at the same time or substantially the same time. As an alternative, the first and second identifier can be directed to the respective electronic devices of the checker and the subject sequentially. For example, the checker can first receive the first identifier and the subject can subsequently receive the second identifier. As an alternative, the subject can first receive the second identifier and the checker can subsequently receive the first identifier.

The first and second identifiers can comprise at least one graphical item, such as at least one color or a series of colors, or at least one visual image or a series of visual images, or a combination of at least one color and visual image. In some examples, the identifier is a visual image, an underlying color (e.g., background color), or the combination of the visual image and the underlying color. In another example, the identifier is a sequence of colors and visual images.

An identifier (e.g., at least one color or series of colors) can be displayed on an electronic display of the checker and/or the subject, such as on a designated area of the electronic display, such as along a corner or center of the display, or at any other location of the display. The identifier can be displayed as a graphical and/or textual item on the electronic display. The identifier can be a color or a series of colors, such as border color, font color, background color, object color (e.g., a colored smiley face). In some cases, an identifier comprising a series of colors and/or images can be a sequence of temporally separated colors and/or images. For example, the first and second identifiers include a color selected from red, orange, yellow, green, blue, indigo and violet, or a combination thereof. As another example, the first and second identifiers include a sequence of colors—for example, red, orange, yellow, green, blue, indigo and violet, or a combination thereof—separated in time. As another example, the first and second identifiers include a sequence of colors and images, such as, for example, red-red-dog-blue-blue-cat. Individual colors and/or images (or other identifiers) of the sequence of colors and/or images (or other identifiers) can be separated by a time period of about 0.5 seconds (s), 1 s, 2 s, 3 s, 4 s, 5 s, 6 s, 7 s, 8 s, 9 s, 10 s, 20 s, 30 s, or more.

Use of the first and second identifier can permit the checker to readily determine whether the subject is to be granted access to the area or location. In some examples, the first and second identifiers comprise a color. The checker can review the color of the first identifier and compare that to the color of the second identifier to determine whether they are the same. If they are the same, then the checker permits the subject to access the area or location; if they are not the same, then the checker does not permit the subject to access the area or location.

The first identifier can be presented on an electronic display of the electronic device of the checker. The second identifier can be presented on an electronic display of the electronic device of the subject. An electronic display can include a user interface (UI), such as a graphical user interface (GUI). The first and second identifier can be presented on a UI on an electronic display of the electronic devices of the checker and the subject.

The electronic device of the checker and/or the electronic device of the subject can be a mobile or portable electronic device, such as a slate or tablet personal computer (e.g., Apple® iPad, Samsung® Galaxy Tab), telephone, Smart phone (e.g., Apple® iPhone, Android-enabled device, Blackberry®), or personal digital assistant. In some situations, the electronic device of the checker can be a stationary electronic device, such as a fixed personal computer (PC) or slate or tablet PC.

In some embodiments, a method for granting an attendee access to an event or location comprises presenting a first identifier on an attendee electronic device of an attendee in response to the attendee requesting admission to the event or location. The first identifier comprises at least one graphical item. Next, a second identifier is presented on a checker electronic device of a checker in response to the attendee requesting admission to the event or location. The checker regulates or monitors access to the event or location. The second identifier is at least partially or entirely the same as the first identifier. Next, an indication is received from the checker electronic device. The indication is indication of whether the attendee has or has not been granted access to the event or location. The indication can be received by a computer server that is in communication with the attendee electronic device and/or the checker electronic device.

The server can direct the attendee electronic device to (i) generate, using a computer processor, the first identifier, and (ii) display the first identifier on an electronic display of the attendee electronic device. The server can direct the checker electronic device to display the second identifier on an electronic display of the checker electronic device.

The indication can be stored in a memory location of the server. In some cases, the indication can be displayed on an electronic display of the attendee electronic device, on an electronic display of the checker electronic device, or both.

The first identifier can be presented on the attendee electronic device when the attendee is at or in proximity to a geographic location of the checker. In some cases, a geographic location of the attendee is determined, such as by the attendee electronic device (e.g., global positioning system or wireless triangulation), and subsequently compared to a geographic location of the checker. If the geographic locations are the same or substantially the same, or within a given distance (e.g., 0.1 miles, 0.2 miles, 0.3 miles, 0.4 miles, or 0.5 miles) from one another, then the attendee is presented with the first identifier. Otherwise, the attendee may not be presented with the first identifier.

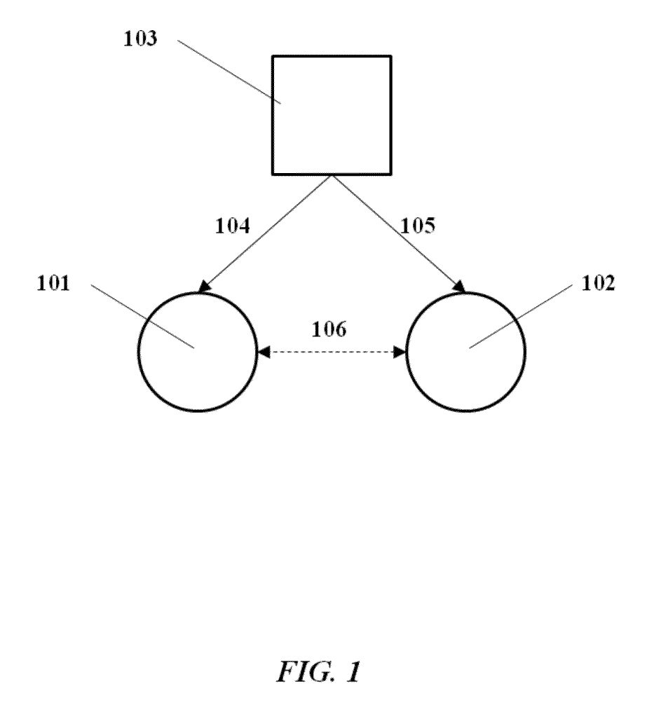

FIG. 1 schematically illustrates a method and system for facilitating subject access to an event, area or location. A subject 101 (or attendee) wishes to be admitted to an event, area or location, the access to which is regulated or monitored by a checker 102. The area or location may be hosting an event, such as a sports game, concert, or party, or may be a bar or restaurant, for example. Both the subject and checker have electronic devices that are in communication with a computer system 103 (or server) that is programmed or otherwise configured to generate identifiers and permit the subject 101 and the checker 102 to receive and review identifiers. In some examples, both the subject 101 and checker 102 have portable (or mobile) electronic devices. When the subject 101 is at or near the checker 102, or at or in proximity to the area or location, the subject 101 requests that the system 103 provide the subject an identifier, which can be a single color or a series of colors (e.g., sequence of colors). The system 103 then directs 104 the identifier to an electronic device of the subject 101. The identifier can be presented on an electronic display of the electronic device of the subject 101. The identifier can be included as part of a ticket (e.g., electronic ticket), or separately from the ticket. The system 103 also directs 105 the identifier to an electronic device of the checker 102. Next, the checker 102 reviews 106 the identifier on the electronic device of the subject 101 to determine whether the identifier on the electronic device of the subject 101 is the same as (or matches) the identifier on the electronic device of the checker 102. If the identifiers are the same, then the checker 102 permits the subject 101 to access (e.g., enter) the area or location. For example, if the identifiers are the color blue, then the checker 102 can determine that the identifiers match and permit the subject 101 to access the area or location.

The system 103 can be programmed or otherwise configured with various features to aid in the robustness of the method. The system 103 can ensure that the identifier presented on the electronic device of the subject 101 and the electronic device of the checker 102 is synchronized. This can help ensure that the checker 102 is reviewing the most current version of the identifier to determine whether the subject 101 is to be granted access to the area or location. In some cases, the system 103 can employ a synchronization process that generates a random (or pseudorandom) number, such as a token, and associates a given identifier (e.g., color or series of colors) with the token. The token along with the identifier are then directed to the electronic device of each of the subject 101 and the checker 102. The system 103 can request that the electronic devices provide their tokens and compare the token from the electronic device of the subject 101 against the token from the electronic device of the checker 102 to determine whether they are the same. The system 103 can direct such request to the electronic devices at least every 0.5 seconds (s), 1 s, 2 s, 3 s, 4 s, 5 s, 6 s, 7 s, 8 s, 9 s, or 10 s. As an alternative, the electronic devices of the subject 101 and the checker 102 can periodically transmit their tokens to the system 103 for comparison. In some examples, the electronic devices transmit their tokens to the system 103 at least every 0.5 seconds (s), 1 s, 2 s, 3 s, 4 s, 5 s, 6 s, 7 s, 8 s, 9 s, or 10 s for comparison by the system 103. This can ensure that the electronic devices of the subject 101 and the checker 102 are on the same temporal page when the tokens are generated by the system 103. If the tokens are the same, then the system 103 determines that the electronic devices of the subject 101 and the checker 102 are synchronized. If the tokens are not the same, then the system 103 can transmit a new token with an identifier to the electronic devices of the subject 101 and the checker 102.

The system 103 can provide a different token with a different identifier to each subject that wishes to be admitted to the area or location. The system 103 can provide a different token with a different identifier to different areas or locations. For example, the system 103 may use different tokens and identifiers with a sports event and a concert.

The system 103 can be programmed or otherwise configured to help prevent fraudulent activity. For instance, the system 103 can provide the identifier to the electronic device of the subject 101 only if the system 103 determines that the subject 101 has paid for access to the area or location, or is otherwise to be permitted access to the area or location. In some cases, the subject 101 can be permitted to request the identifier from the system 103 when the subject 101 is at or within a given distance (e.g., 100 feet, 10 feet, 5 feet, or 1 foot) from the checker 102 or the area or location. In some example, the electronic device of the subject comprises a geographic location (“geolocation”) device that transmits the geolocation of the subject 101 to the system 103 so that the system 103 can determine whether the subject 101 is within the requisite distance to request the identifier from the system 103. This can help ensure that the checker 102 reviews the identifier of the subject 101 when the subject 101 is at or near (e.g., within 10 feet, 5 feet, or 1 foot from) the point of entry to the area or location, which can help minimize duplication of the identifier by another subject—e.g., the subject 101 is provided the identifier for review by the checker 102 within a narrow window of time, which can help prevent other subjects from duplicating the identifier and entering the area or location without having paid for admission. In addition, each subject may be provided with a unique identifier (e.g., series of colors) that may be different from the identifier of another subject.

In an example, the subject 101 arrives at the location of the event. The system 103, through an electronic device of the subject 101, determines that the subject is at the location. The system 103 then permits the checker 102 to check the subject 101 into the event.

### Computer Systems for Granting Subject Access

The present disclosure provides computer control systems that are programmed or otherwise configured to implement methods of the disclosure. In an aspect, a system for regulating attendee access to an event or location comprises an attendee electronic device that is operated by an attendee, a checker electronic device that is operated by a checker that regulates or monitors access to the event or location, and a computer server (also “server” herein) that is in communication with the attendee electronic device and/or the checker electronic device.

In some embodiments, the attendee electronic device is programmed to present the attendee with a first identifier in response to the attendee requesting admission to the event or location, wherein the first identifier comprises at least one graphical item. The checker electronic device is programmed to present the checker with a second identifier in response to the attendee requesting admission to the event or location, wherein the second identifier is at least partially the same as the first identifier. The server receives an indication from the checker electronic device that the attendee has or has not been granted access to the event or location.

In some cases, the sever directs the attendee electronic device to (i) generate, using a computer processor, the first identifier, and (ii) display the first identifier on an electronic display of the attendee electronic device. The server can direct the checker electronic device to display the second identifier on an electronic display of the checker electronic device. In some cases, the server directs the attendee electronic device to generate and display the first identifier when the server determines that the attendee is at or in proximity to a geographic location of the checker, or at or in proximity to a geographic location of the event or location. In such a case, the server can direct the attendee electronic device to present the first identifier to the attendee. The server can determine whether the attendee is at or in proximity to the geographic location of the checker or the event or location using a geographic location system of the attendee electronic device, such as a global positioning system (GPS) or wireless triangulation.

FIG. 2 shows a computer system 201 that is programmed or otherwise configured to facilitate subject access to an area or location. The computer system 201 can be a computer sever, such as a server that is in communication with an electronic device of an attendee, an electronic device of a checker, or both. The computer system 201 can regulate various aspects of methods of the present disclosure, such as, for example, generating identifiers and directing identifiers to electronic devices of subjects for review by checkers.

The computer system 201 includes a central processing unit (CPU, also “processor” and “computer processor” herein) 205, which can be a single core or multi core processor, or a plurality of processors for parallel processing. The computer system 201 also includes memory or memory location 210 (e.g., random-access memory, read-only memory, flash memory), electronic storage unit 215 (e.g., hard disk), communication interface 220 (e.g., network adapter) for communicating with one or more other systems, and peripheral devices 225, such as cache, other memory, data storage and/or electronic display adapters. The memory 210, storage unit 215, interface 220 and peripheral devices 225 are in communication with the CPU 205 through a communication bus (solid lines), such as a motherboard. The storage unit 215 can be a data storage unit (or data repository) for storing data. The computer system 201 can be operatively coupled to a computer network (“network”) 230 with the aid of the communication interface 220. The network 230 can be the Internet, an internet and/or extranet, or an intranet and/or extranet that is in communication with the Internet. The network 230 in some cases is a telecommunication and/or data network. The network 230 can include one or more computer servers, which can enable distributed computing, such as cloud computing. The network 230, in some cases with the aid of the computer system 201, can implement a peer-to-peer network, which may enable devices coupled to the computer system 201 to behave as a client or a server.

The CPU 205 can execute a sequence of machine-readable instructions, which can be embodied in a program or software. The instructions may be stored in a memory location, such as the memory 210. Examples of operations performed by the CPU 205 can include fetch, decode, execute, and writeback.

The storage unit 215 can store files, such as drivers, libraries and saved programs. The computer system 201 in some cases can include one or more additional data storage units that are external to the computer system 201, such as located on a remote server that is in communication with the computer system 201 through an intranet or the Internet.

The computer system 201 can communicate with one or more remote computer systems through the network 230. In the illustrated example, the system 201 is in communication with an electronic device of a subject 235 and an electronic device of a checker 240, which can be remotely located with respect to the system 201. The electronic devices can include geolocation systems that permit identification of a geolocation of the subject 235 and checker 240. The electronic device of the subject 235 and the electronic device of the checker 240 can each include one or more computer processors and computer memory in communication with the one or more computer processors. Each of the electronic devices of the subject 235 and the checker 240 can include an electronic display for providing a user interface, such as a graphical user interface. In some example, the electronic display of each of the electronic devices of the subject 235 and the checker 240 is a computer monitor or a capacitive or resistive touch screen.

The system 201 can be in communication with the electronic devices through the network 230. Examples of the electronic devices 235 and 240 include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The electronic devices 235 and 240 can be mobile (or portable) or fixed electronic devices.

Methods as described herein can be implemented by way of machine (e.g., computer processor) executable code stored on an electronic storage location of the computer system 201, such as, for example, on the memory 210 or electronic storage unit 215. The machine executable or machine readable code can be provided in the form of software. During use, the code can be executed by the processor 205. In some cases, the code can be retrieved from the storage unit 215 and stored on the memory 210 for ready access by the processor 205. In some situations, the electronic storage unit 215 can be precluded, and machine-executable instructions are stored on memory 210.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 201, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 201 can include or be in communication with an electronic display that comprises a user interface (UI) for providing, for example, identifiers. Examples of UI's include, without limitation, a graphical user interface (GUI) and web-based user interface. In some example, the electronic display is a computer monitor or a capacitive or resistive touch screen.

Methods and systems of the present disclosure can be facilitated using applications (or “apps”) installed on electronic devices of checkers and subjects. An app can be programmed or otherwise configured to display an identifier on an electronic device of a subject and checker, along with other information, such as a ticket of the subject.

FIG. 3 shows a user interface 301 of an app that is configured to permit subjects (or attendees) to be checked into a given event or location. The user interface 301 comprises multiple menu items 302-305 that permit a subject to navigate through various features of the app. The menu items 302-305 can be static and not change as the user navigates through various menu items 302-305. A first menu item 302 is an events menu item which permits the subject to view events that the subject has requested admission to, such as by purchasing a ticket. A second menu item 303 is a discover menu item, which permits the subject to discover events at or near a geolocation of the subject, or at a location selected by the subject. From the second menu item 303, the subject can discover other events and request admission to those events. A third menu item 304 is a coupons menu item, which permits the subject to view available coupons or other rewards that may be relevant to the subject. Examples of coupons include discounts to events. A fourth menu item 305 is a profile menu item, which permits the subject to view a profile (e.g., name, likes and dislikes, etc.) of the subject as maintained on the system.

The user interface 301 further includes a first area 306 that presents a ticket for admission to a given event, which can be presented to the subject when the subject selects the given event from the first menu item 302. The ticket can include barcode or other graphical, numeral and/or textual information that is specific to the given event or permits a checker to determine whether the subject is to be permitted to the given event. When the subject is at a point of check in to the event, the first area 306 can display an identifier, which can include at least one graphical item or a sequence of graphical items. For example, the identifier can be a color or a sequence of colors. The identifier can permit the check to check the subject into the given event.

The user interface 301 further includes a second area 307 that includes a list of attendees to the given event. The list can include the subject. The list can include identifying information of an attendee and a check-in status (e.g., arrived, not arrived, checked-in) of an attendee, including the subject. For example, when an attendee has not arrived at the location of the given event, then the status of the attendee can be “not arrived.” Upon arrival of the attendee to the location, the status of the attendee can be “arrived.” Once the attendee has been checked into the event by the checker, the status of the attendee can be “checked in.”

### Example 1

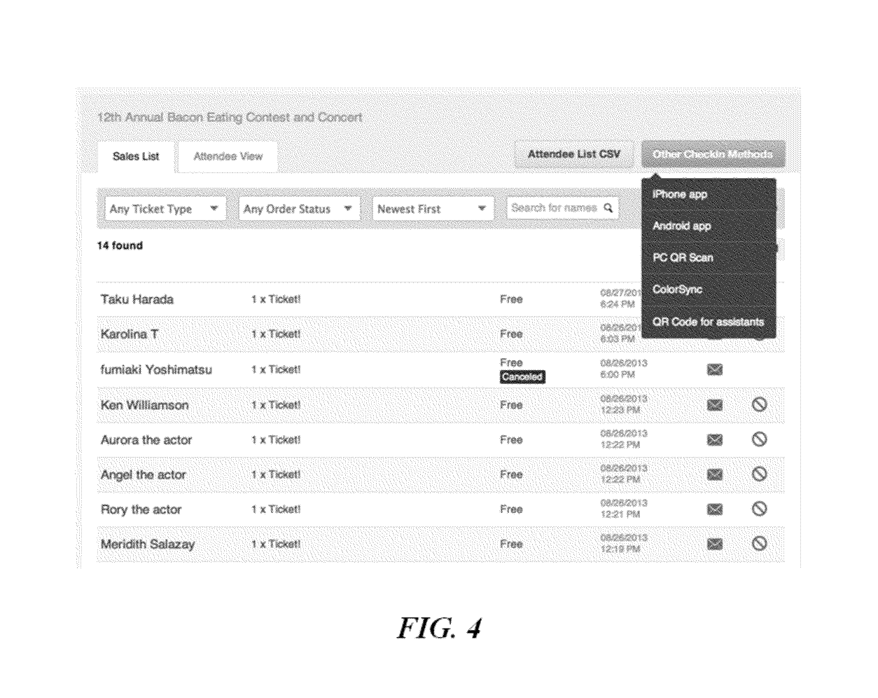

FIGS. 4-7 show example screenshots of graphical user interfaces, which show identifiers for facilitating subject access to an event that is held at a given location.

With reference to FIG. 4, when an event organizer (checker) signs in to check in subjects (potential attendees), the event organizer has the option to check in the attendees conventionally, such as using a ticket, or using a ticket in combination with an identifier (“ColorSync”). The screenshot of FIG. 4 is a GUI that is displayed on an electronic display of an electronic device of the checker. The GUI displays a list of subjects (far left column) and the number of tickets that each subject has (column to the right of the far left column). The top-right drop-down menu shows the manner in which the checker can check a subject into the event.

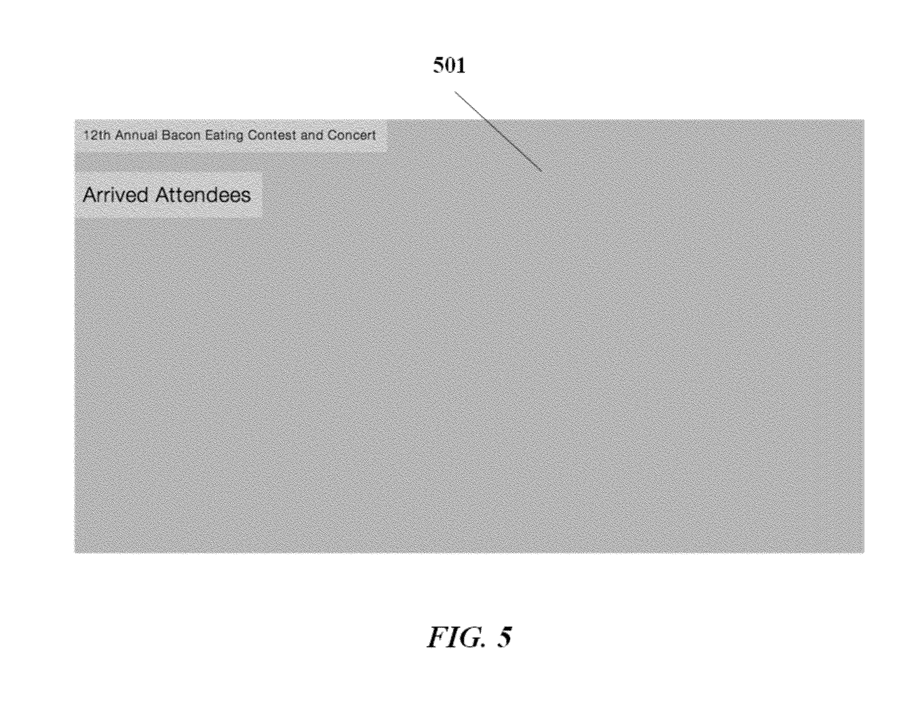

With reference to FIG. 5, the checker has selected the ColorSync option from the drop-down menu of FIG. 4 and a window is displayed on the electronic display of the checker that flashes an identifier that includes one or more background colors. A background 501 of the GUI of FIG. 5 can flash colors (e.g., the same color or different colors) in sequence, such as a sequence of colors that are spaced 1 second apart. For example, the color of the background 501 can change from red to red to blue in sequence, and repeat, until the checker has determined that the subject is to be admitted to the event.

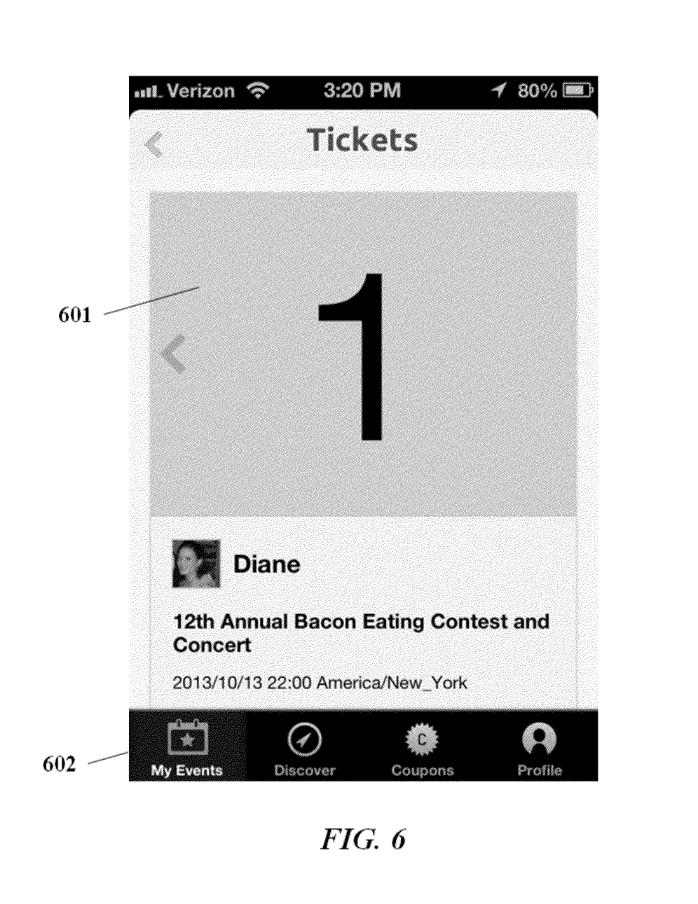

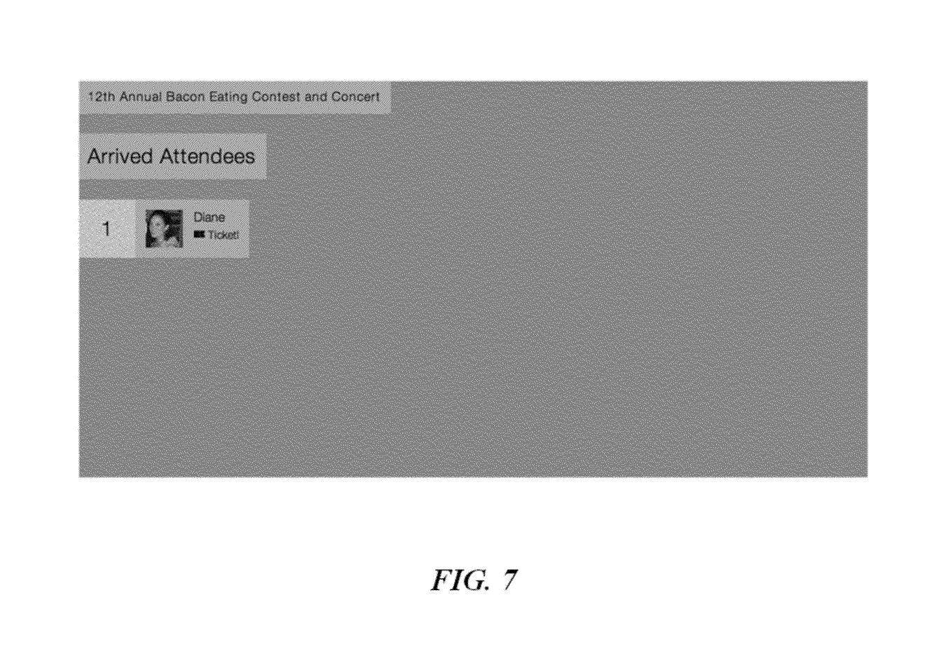

FIG. 6 shows an app with a GUI that is displayed on an electronic display of an electronic device of a subject. The GUI shows a ticket to the event, including a name and picture of the attendee, and a title of the event. The GUI of FIG. 6 displays the identifier in unison with the identifier displayed on the electronic display of the checker. The identifier of the GUI of FIG. 5 is displayed by way of colors displayed in a background 501. In the illustrated example, the GUI of FIG. 6, in a background 601, flashes colors in sequence in unison with flashing the colors on the electronic display of the checker. For example, the colors red, red and blue are displayed sequentially and simultaneously on the electronic displays of the checker and the subject. The checker then reviews the colors displayed in the background 601 on the electronic display of the subject and compares those colors to the colors on the electronic display of the checker. If the colors match, then the checker grants the subject access to the event. FIG. 7 shows the GUI of the checker with the subject (“Diane”) granted access to the event.

The GUI of the subject can provide the subject with various features. With reference to FIG. 6, a menu 602 of the GUI has various selectable menu items. The “My Events” menu item enables the subject to view events that the subject is scheduled to attend, such as by way of a purchased ticket. The “Discover” menu item enables the subject to find other events at a designated location, such as at a given city or at or in proximity to a geolocation of the subject. The “Coupons” menu items presents promotions that are available to the subject, such event discounts (e.g., discount to a concert). The “Profile” menu item enables the subject to build a profile that may include a name and location of the subject, and payment information. The payment information can enable the subject to purchase a ticket to an event from the “Discover” menu item.

### Example 2

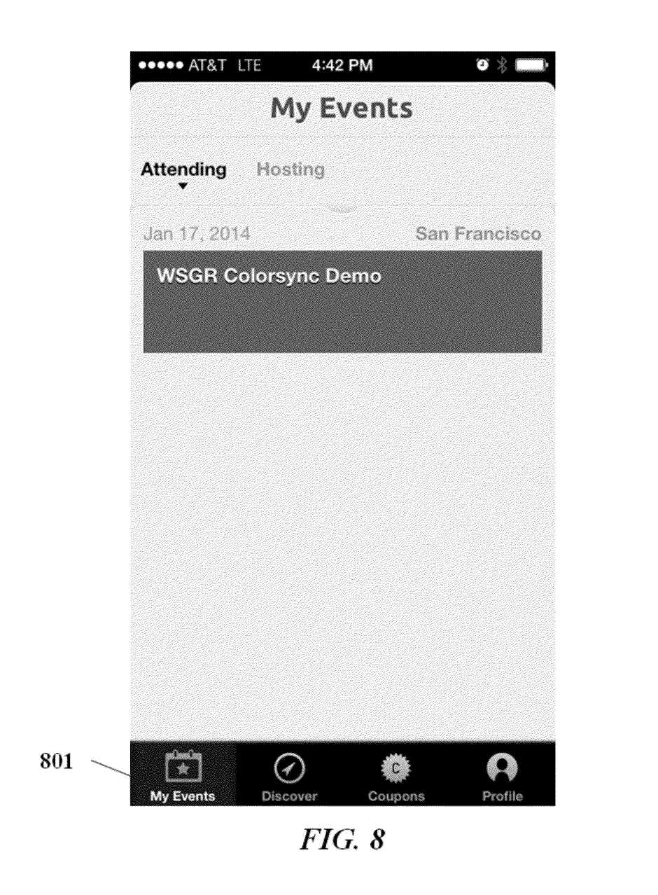

FIGS. 8-14 show screenshots of a user interface of an application (app) that is configured to enable a subject to search for and find events and check into an event.

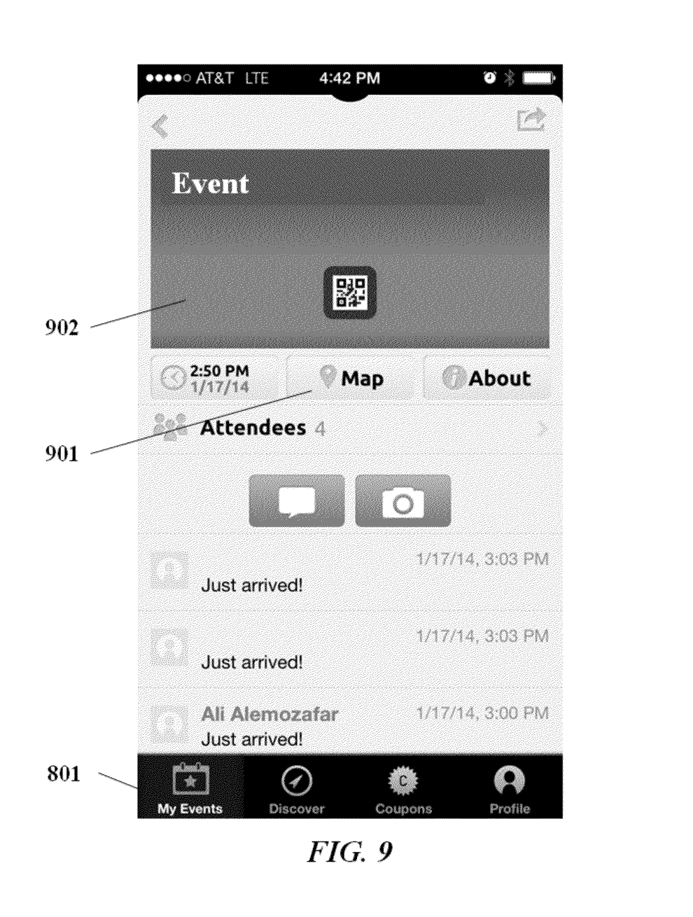

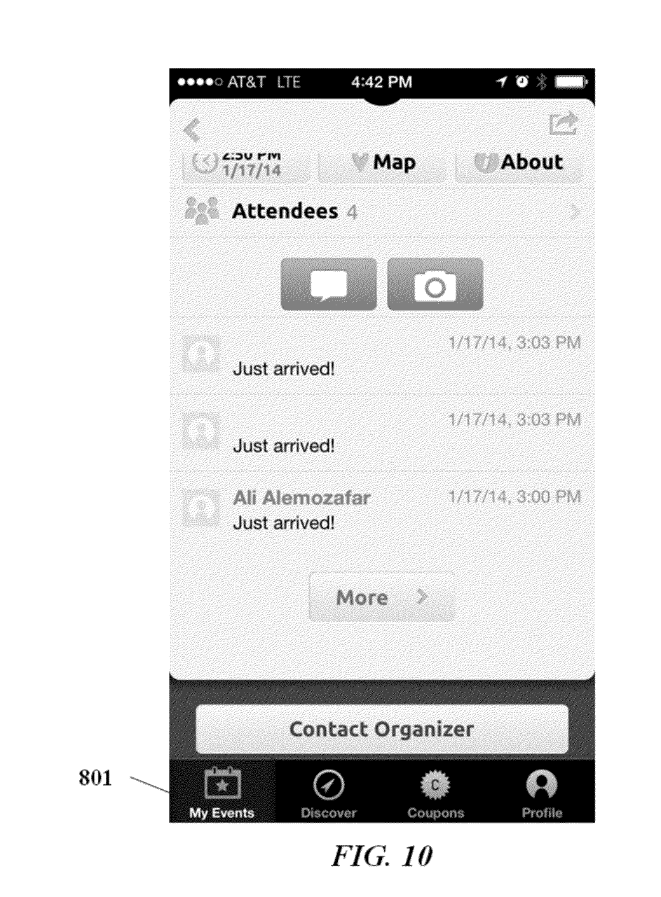

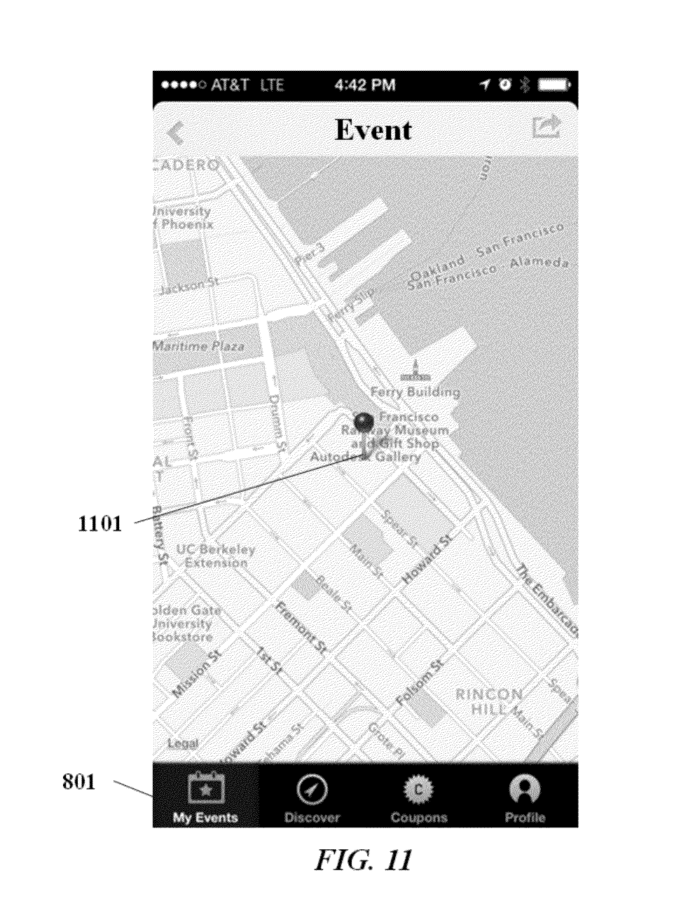

FIG. 8 shows an events (“My Events”) screen that displays events or activities that an attendee is planning to attend. The user interface displays the date (“Jan. 17, 2014”) and location (“San Francisco”) of the event. The screen of FIG. 8 shows a static navigation menu 801 that includes various menu items (“My Events,” “Discover,” “Coupons,” and “Profile”). When the attendee selects an event form the screen of FIG. 8, the screen of FIGS. 9-10 can be displayed. The screens of FIGS. 9-10 show various features, such as the number of attendees attending or planning to attend the event, their attendance statuses (e.g., “Just arrived!”), and various buttons, such as a map button 901 that permits the attendee to view a location of the attendee and navigate to the event or location. When the attendee selects the map button 901, the screen of FIG. 11 can be displayed, which shows a present geolocation 1101 of the attendee.

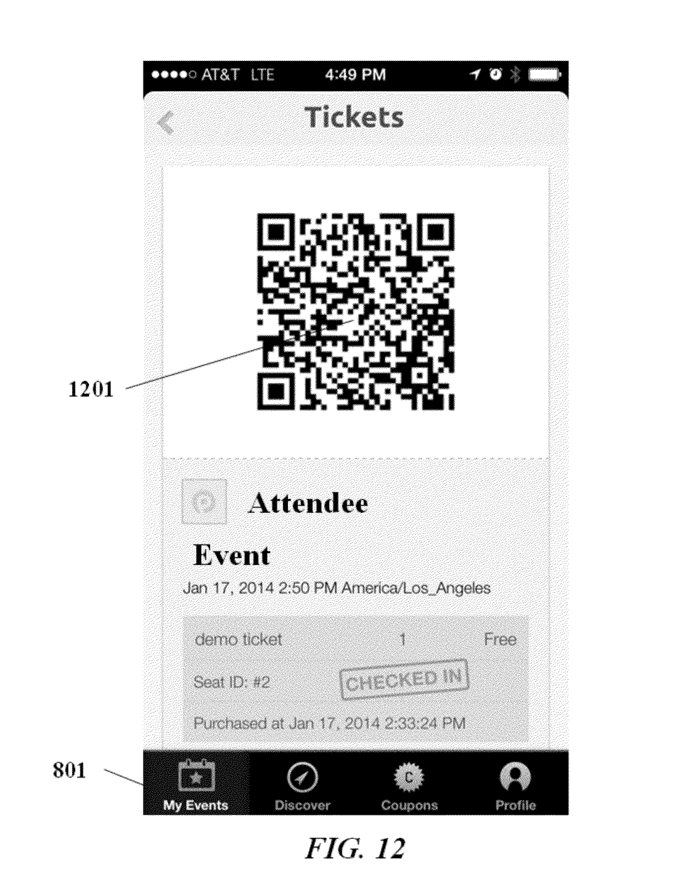

With reference to FIG. 9, an area 902 displays a ticket of the attendee. In the illustrated example, the ticket is a bar code. When the attendee selects the ticket, the screen of FIG. 12 can be displayed, which presents a ticket 1201 (bar code, in the illustrated example). When the attendee is at or in proximity (e.g., within 0.01 miles or 0.1 miles) of a geolocation of the event or location, the attendee can select the ticket 1201 to display an identifier (e.g., sequence of colors) for review by a checker at the event or location.

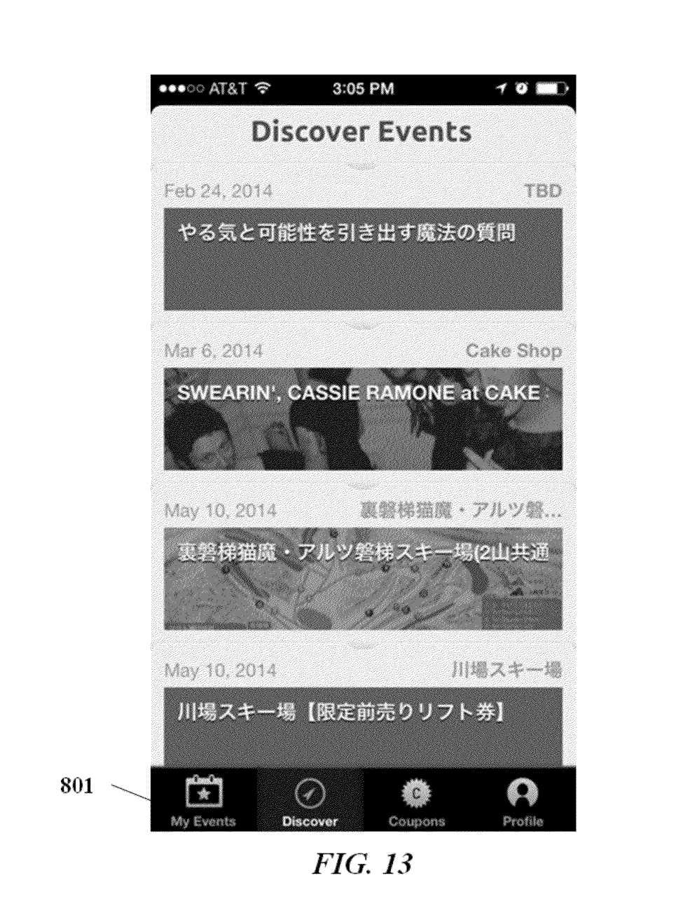

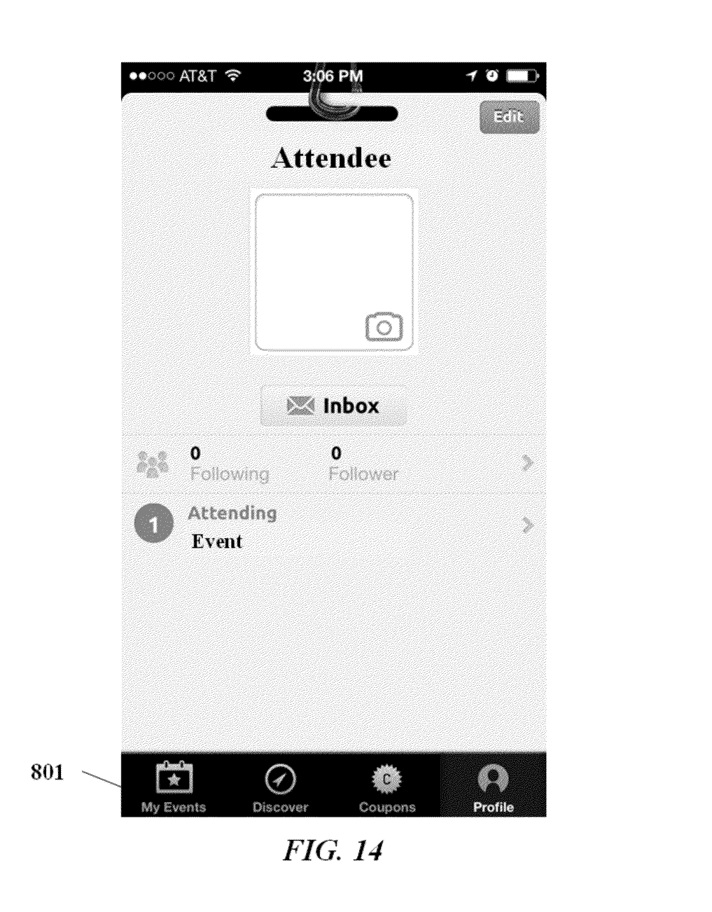

The attendee can select a discover menu item from the navigation menu 801, which enables the attendee to search for and discover events that are at or in proximity to a geolocation of the attendee, or at a given location selected by the attendee (e.g., Brooklyn, N.Y.). Selecting the discover menu item can display the screen of FIG. 13, which shows various events listed by event date. The attendee can select an event from the list to get details about the event. The attendee can select a profile menu item from the navigation menu 801, which can display the screen of FIG. 14 showing a profile of the attendee. The profile also displays an electronic message inbox of the attendee, which enables the attendee to read and respond to electronic communications from other users. The profile displays a number of followers of the attendee and a number of users that the attendee is following. The profile can also display a number of events that the attendee is attending, has attended and/or planning to attend. A picture or avatar of the attendee can be displayed in the profile.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for granting an attendee access to an event or location, comprising:
(a) presenting a first identifier on an attendee electronic device of an attendee in response to said attendee requesting admission to said event or location, wherein said first identifier comprises at least one graphical item;
(b) presenting a second identifier on a checker electronic device of a checker in response to said attendee requesting admission to said event or location, wherein said checker regulates or monitors access to said event or location, and wherein said second identifier is at least partially the same as said first identifier; and
(c) receiving an indication from said checker electronic device that said attendee has been granted access to said event or location.

2. The method of claim 1, wherein (a) further comprises directing said attendee electronic device to (i) generate, using a computer processor, said first identifier, and (ii) display said first identifier on an electronic display of said attendee electronic device.

3. The method of claim 1, wherein (b) further comprises directing said checker electronic device to display said second identifier on an electronic display of said checker electronic device.

4. The method of claim 1, further comprising storing said indication received in (c) in a memory location.

5. The method of claim 1, further comprising displaying said indication on an electronic display of said attendee electronic device.

6. The method of claim 1, further comprising displaying said indication on an electronic display of said checker electronic device.

7. The method of claim 1, wherein said at least one graphical item is a color.

8. The method of claim 1, wherein said first or second identifier comprises a sequence of temporally separated graphical items.

9. The method of claim 8, wherein said first or second identifier comprises a sequence of colors.

10. The method of claim 1, wherein said first identifier is presented when said attendee is at or in proximity to a geographic location of said checker.

11. The method of claim 10, wherein (a) further comprises (i) determining a geographic location of said attendee and (ii) comparing said geographic location to said geographic location of said checker.

12. The method of claim 1, wherein said second identifier is the same as said first identifier.

13. A system for regulating attendee access to an event or location, comprising:
(a) an attendee electronic device that is operated by an attendee, wherein said attendee electronic device is programmed to present said attendee with a first identifier in response to said attendee requesting admission to said event or location, wherein said first identifier comprises at least one graphical item;
(b) a checker electronic device that is operated by a checker that regulates or monitors access to said event or location, wherein said checker electronic device is programmed to present said checker with a second identifier in response to said attendee requesting admission to said event or location, wherein said second identifier is at least partially the same as said first identifier;
(c) a server that is in communication with said attendee electronic device and said checker electronic device, wherein said server receives an indication from said checker electronic device that said attendee has been granted access to said event or location.

14. The system of claim 13, wherein said sever directs said attendee electronic device to (i) generate, using a computer processor, said first identifier, and (ii) display said first identifier on an electronic display of said attendee electronic device.

15. The system of claim 13, wherein said server directs said checker electronic device to display said second identifier on an electronic display of said checker electronic device.

16. The system of claim 13, wherein said server comprises memory that stores said indication.

17. The system of claim 13, wherein said at least one graphical item is a color.

18. The system of claim 13, wherein said first or second identifier comprises a sequence of temporally separated graphical items.

19. The system of claim 18, wherein said first or second identifier comprises a sequence of colors.

20. The system of claim 13, wherein said server (i) determines whether said attendee is at or in proximity to a geographic location of said checker, and (ii) directs said attendee electronic device to present said first identifier when said attendee is at or in proximity to said geographic location.

21. The system of claim 20, wherein said server determines whether said attendee is at or in proximity to said geographic location of said checker using a geographic location system of said attendee electronic device.

22. The system of claim 13, wherein said second identifier is the same as said first identifier.

23. A computer readable medium comprising machine executable code that, upon execution by one or more computer processors implements a method for granting an attendee access to an event or location, the method comprising:
(a) presenting a first identifier on an attendee electronic device of an attendee in response to said attendee requesting admission to said event or location, wherein said first identifier comprises at least one graphical item;
(b) presenting a second identifier on a checker electronic device of a checker in response to said attendee requesting admission to said event or location, wherein said checker regulates or monitors access to said event or location, and wherein said second identifier is at least partially the same as said first identifier; and
(c) receiving an indication from said checker electronic device that said attendee has been granted access to said event or location.
